(19) United States
(12) Patent Application Publication
(10) Pub. No.: US 2026/0054436 A1
(43) Pub. Date: Feb. 26, 2026

(54) INJECTION MOLDING TOOL, METHOD TO MOLD A MOLDING ELEMENT TO AN INSERT ELEMENT IN AN INJECTION MOLDING TOOL, AND MOLDING PRODUCT

(71) Applicants: HELLA GMBH & CO. KGAA, Lippstadt (DE); HELLA (XIAMEN) ELECTRONIC DEVICE CO., LTD., Xiamen (CN)

(72) Inventors: Fabian Evers, Delbrueck (DE); Heinz-Peter Kleeschulte, Anroechte (DE); Feng Li, Xiamen (CN)

(21) Appl. No.: 19/327,006

(22) Filed: Sep. 12, 2025

Related U.S. Application Data
(63) Continuation of application No. PCT/CN2023/081659, filed on Mar. 15, 2023.

(51) Int. Cl. B29C 45/37; B29C 45/26

(52) U.S. Cl. CPC B29C 45/37; B29C 45/2675

(57) ABSTRACT

An injection molding tool for molding a molding element to an insert element that is insertable in the injection molding tool includes a first mold part with a first mold surface for delimiting a mold cavity and a second mold part with a second mold surface for delimiting the mold cavity. The first mold part and the second mold part form the mold cavity in the closed state of the injection molding tool. A first restriction element is arranged on the first mold surface for restricting a mold flow during an injection process of the molding element and/or a second restriction element is arranged on the second mold surface for restricting the mold flow during the injection process of the molding element.

### CROSS-REFERENCE TO RELATED APPLICATIONS

The present application is a continuation of PCT/CN2023/081659, filed Mar. 15, 2023, the disclosure of which is incorporated by reference in its entirety.

### FIELD OF THE INVENTION

The invention relates to an injection molding tool, a method to mold a molding element to an insert element, and a molding product.

### BACKGROUND OF THE INVENTION

Various processes and tools for injecting a component or element onto an existing component are already known from the prior art. For this purpose, an existing component is placed in an injection mold, the mold is closed, and then the material of the component to be injected is injected.

The problem often arises at the transition between the two components, the injected material overflows or reaches areas where it is not supposed to be. Additional post-processing steps are then required to remove the undesirable overflows or to produce smooth transitions between the components. This increases post-processing time and the associated costs.

### SUMMARY OF THE INVENTION

It is the object of the present invention to at least partially solve the above-described disadvantages. In particular, it is the object of the present invention to provide a simple and/or inexpensive tool and associated method that reduces the post-processing time and thereby lowers the costs, when manufacturing an injected product.

The above object is achieved by an injection molding tool having the features of the current embodiments, a method to mold a molding element to an insert element in an injection molding tool having the features of the current embodiments, and a molding product having the features of the current embodiments. Further features and details of the invention result from the sub claims, the description and the drawings. Features and details described in connection with the injection molding tool according to the invention naturally also apply in connection with the method according to the invention and/or the molding product according to the invention and vice versa in each case, so that reference is or can always be made mutually with respect to the disclosure of the individual aspects of the invention.

According to a first aspect, the present invention discloses an injection molding tool for molding a molding element to an insert element that is insertable in the injection molding tool, wherein the injection molding tool comprises: a first mold part with a first mold surface for delimiting a mold cavity; a second mold part with a second mold surface for delimiting the mold cavity, wherein the first mold part and the second mold part form the mold cavity in the closed state of the injection molding tool. Thereby a first restriction element is arranged on the first mold surface for restricting a mold flow during an injection process of the molding element and/or a second restriction element is arranged on the second mold surface for restricting the mold flow during the injection process of the molding element.

The first and second restriction elements are arranged such that the mold cavity is divided into the form of the insert element and the molding element. The shapes of the insert element and the molding element may overlap or have recesses.

The mold is used to overmold a further component (molding element) onto a first component (insert element). The mold is also suitable for overmolding further sections of the first component in order to produce a cover.

The first and second restriction elements prevent overmolding in certain areas, such as the transition between the insert element and molding element. This results in a final product that requires fewer steps in post-processing, therefore being more time and cost efficient.

Furthermore, the improved sealing of the inserted insert element during the molding process stabilizes the molding process.

The first and second restricting elements may extend continuously or in sections in the first and second mold parts, respectively. The extension depends on the shape of the molding element or insert element, the desired course of the transition and the mold material.

The first and/or second mold parts may be monolithic and/or one-piece with the respective restriction element. Monolithic is understood to mean that it was manufactured from a single “casting”. A one-piece mold part can have a subsequently applied, e.g. welded-on, restriction element.

In particular, the first mold part of the injection molding tool is formed in several parts, and/or the second mold part of the injection molding tool is formed in several parts.

A multi-part design of the individual mold parts leads to simplified demolding. Furthermore, the individual parts can be adapted more quickly to modifications in the design of the insert element and/or molding element. Further, the individual parts of the mold parts can easily be replaced when worn out. This allows the parts or the part comprising the first and/or second restriction element to be replaced as soon as the restriction element is worn out without having to replace the entire mold.

It may be advantageous to the injection molding tool if the first restriction element and/or the second restriction element is a restriction edge.

This restriction edge changes the flow of the mold flow in a simple way, because it has to change its direction. This slows down the flow. At the same time, the restriction edge can shear the flow, and thereby slowing it down.

It may be advantageous with the injection molding tool if the cross section of the first restriction element and/or the second restriction element is in the shape of a triangle, in particular an equilateral triangle, or a trapezeoid, in particular a symmetrical trapezeoid.

It is understood that the base of the trapezoid is arranged on the respective tool part, and the much smaller side running parallel to the base is assigned to the insert element. This allows the shape of the restriction element to be adapted to the geometry to be molded onto the insert element. Furthermore, the shape of the restriction element can be adapted to the requirements. The restriction element can be selected so that the transition has a straight or beveled edge.

It may be advantageous with the injection molding tool if the first mold part and/or the second mold part comprise at least one heating element, wherein the at least one heating element is arranged next to the first restriction element and/or the second restriction element.

Heating the areas, in particular the area with the first and/or second restriction element, with the heating element will solidify the mold quickly. The heating element may be variable in placement along the mold parts. The arrangement of the heating elements can rapidly accelerate the solidification of the mold and thus significantly influence the flow and edge formation.

It may be advantageous with the injection molding tool if the first restriction element and/or the second restriction element has a height between 0 to 0.5 mm, in particular 0.01 to 0.3 mm, further in particular 0.05 to 0.2 mm.

The height of the respective restriction element depends on the size of the insert element and/or molding element. The height can be selected to slow and modify the flow so that the area of solidification requires less post-processing time. This reduces processing time and costs.

It may be advantageous with the injection molding tool if the first restriction element and/or the second restriction element has at least one interruption for flow redirection.

This affects the flow in the injection molding process as it forces the flow to change direction.

It may be advantageous with the injection molding tool if the first restriction element and/or the second restriction element is subdivided into segments, wherein the segments are arranged offset, and in particular overlapping, to each other.

This affects the flow in the injection molding process as it forces the flow to change direction.

According to a second aspect, the present invention discloses a method to mold a molding element to an insert element in an injection molding tool according to the description above, comprising the following steps: providing the first mold part with the first mold surface, wherein the first restriction element is arranged on the first mold surface; providing the second mold part with the second mold surface, wherein the second restriction element is arranged on the second mold surface; inserting the insert element in the first mold part; placing the second mold part on the first mold part to form the mold cavity, thereby closing the injection molding tool; filling the mold cavity of the injection molding tool with mold material to mold the molding element to the insert element, whereby the mold flow of the mold material is influenced by the first restriction element and/or second restriction element.

Due to the improved sealing or restriction of the insert element by means of the first and/or second restriction element in this method, the mold flow is improved as the pressure distribution is more uniform. An improved method to mold a molding element to an insert element leads to an improved result, so that the post-processing can be reduced. As a result, manufacturing time and costs are reduced.

In particular, the insert element is inserted into the first mold part adjacent to the first restriction element and/or the second mold part is placed on the first mold part such that the insert element is adjacent to the second restriction element.

The pressure distribution in the injection molding tool during the filling of the mold can be optimized in a simple way due to the adjacent arrangement of the insert element to the first and/or second restriction element.

It may be advantageous with the injection molding tool if the first restriction element and/or the second restriction element penetrate the insert element and/or molding element in the closed state with a penetration depth.

The penetration depth prevents overmolding in certain areas, in particular the areas where the molding element is molded to the insert element. This ensures a clean transition between the insert element and the molding element. A clean transition reduces the time and costs of post-processing.

It may be advantageous with the method if the penetration depth of the first restriction element in the insert element and/or the second restriction element in the insert element is 0 to 0.5 mm, in particular, 0.01 to 0.3 mm, and further, in particular 0.05 to 0.2 mm.

These ranges in depth ensure that the first and/or second restriction element penetrates deep enough such that overmolding of the area where the molding element is molded to the insert element is provided. The penetration depth may be continuous over the extension of the first and/or second restriction elements. It is conceivable that the penetration depth varies along the extension of the first and/or second restriction elements. This provides clear edges in the area of the transition between the insert element and the molding element, so that no post-processing after the molding is reduced.

It may be advantageous with the method if the insert element is inserted into the first mold part at a distance from the first restriction element and/or the second mold part is placed on the first mold part such that the insert element is at a distance from the second restriction element.

The distance between the first and/or second restriction elements can be adjusted depending on the desired impact on the flow. This can be selected in such a way that a vortex forms behind the first and/or second restriction element and in front of the insert element, which slows down the flow and thus positively influences the solidification of the mold material.

In particular, the distance between the first restriction element and the insert element and/or the second restriction element is 0 to 0.5 mm, in particular 0.01 to 0.3 mm, and further, in particular 0.05 to 0.2 mm.

Distances in this area ensure that the fusion area is clean and requires little post-processing. At the same time, it is easier to produce these distances when manufacturing the mold parts.

According to a third aspect, the present invention discloses a molding product comprising an insert element and a molding element, whereby the molding element is molded to the insert element according to the method described above

Advantages that have been described in detail for the injection molding tool according to the first aspect of the invention also apply accordingly to the method to mold a molding element to an insert element in an injection molding tool and to the molding product according to the second and third aspects of the invention.

Further measures for improving the invention result from the following description of some examples of implementation of the invention, which are shown schematically in the figures. All features and/or advantages arising from the claims, the description or the drawings, including constructional details, spatial arrangements and process steps, may be essential to the invention both individually and in the various combinations. It should be noted that the figures are descriptive only and are not intended to limit the invention in any way.

### BRIEF DESCRIPTION OF THE DRAWINGS

The figures show schematically:

FIG. 1 illustrates a first mold part of an injection molding tool;

FIG. 2 illustrates a section of a first mold part of an injection molding tool with a segmented restriction element;

FIG. 3 illustrates a first mold part of an injection molding tool in a cross sectional view;

FIG. 4 illustrates a section of FIG. 3 showing a first embodiment of a restriction element;

FIG. 5 illustrates a section of FIG. 3 showing a second embodiment of a restriction requirement;

FIG. 6 illustrates a method to mold a molding element to an insert element in an injection molding tool according to FIG. 1 to FIG. 4; and

FIG. 7 illustrates a molding product manufactured with the method of FIG. 6.

### DETAILED DESCRIPTION OF THE CURRENT EMBODIMENT

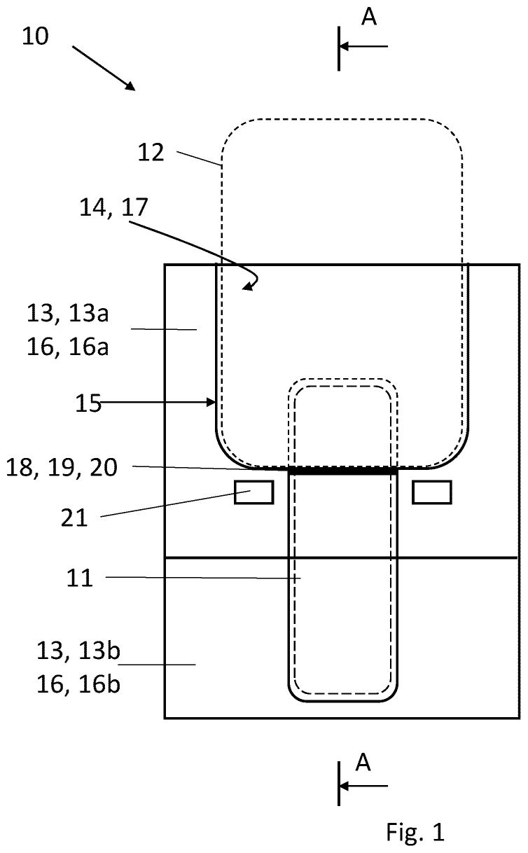

The FIG. 1 to 5 show an injection molding tool 10 for molding a molding element 11 to an insert element 12 that is insertable in the injection molding tool 10. The insertable insert element 12 and the molding element 11 are shown in dashed lines. FIG. 1 to FIG. 4 show only the first mold part of the injection molding tool 10. However, the figures apply equally to the second mold part 16, 16a, 16b. Accordingly, the first mold part 13, 13a, 13b and second mold parts 16, 16a, 16b and their respective properties will continue to be discussed.

The injection molding tool 10 comprises a first mold part 13 with a first mold surface 14 for delimiting a mold cavity 15 and a second mold part 16 with a second mold surface 17 for delimiting the mold cavity 15, wherein the first mold part 13 and the second mold part 16 form the mold cavity 15 in the closed state of the injection molding tool 10. Thereby a first restriction element 18 is arranged on the first mold surface 14 for restricting a mold flow during an injection process of the molding element 11 and/or a second restriction element 19 is arranged on the second mold surface 17 for restricting the mold flow during the injection process of the molding element 11.

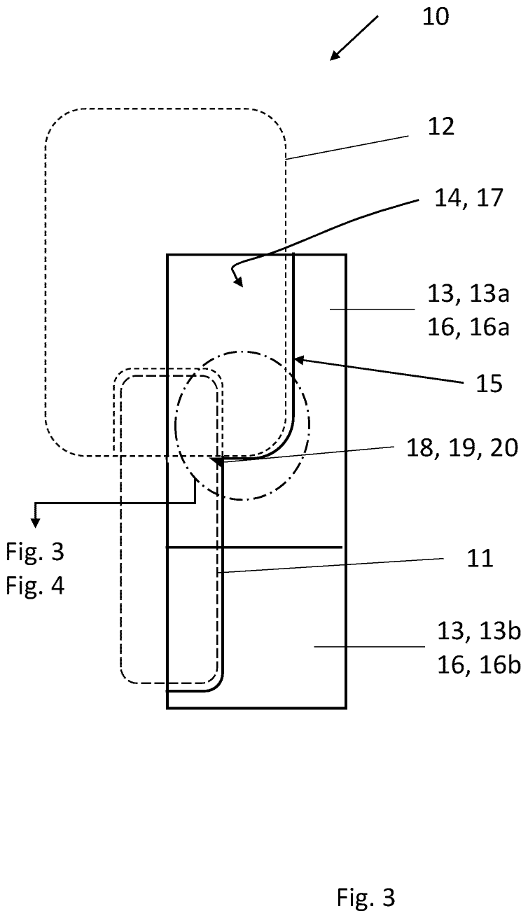

The first mold part 13 as shown in FIG. 1 and FIG. 3 is formed in several parts 13a, 13b. This applies to the second mold part 16, 16a, 16b as well. In order to achieve the optimum sealing effect, the first restriction element 18 and/or the second restriction element 19 is a restriction edge 20. This can be seen in particular in the section of FIG. 5.

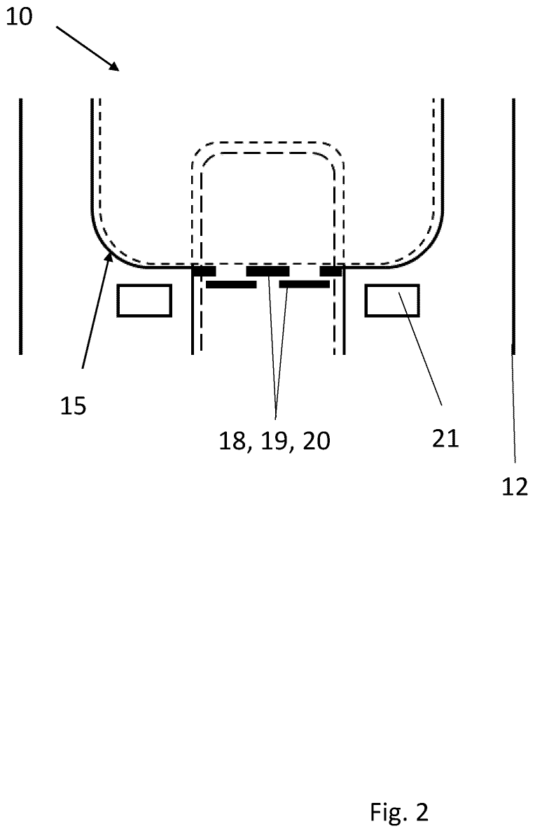

FIG. 2 shows a first restriction element 18 which is subdivided into segments, such that the restriction element has at least one interruption for flow redirection. In this embodiment, these segments are arranged offset and are overlapping, thereby covering interruptions by the segments to redirect the flow of the mold during the injection molding process.

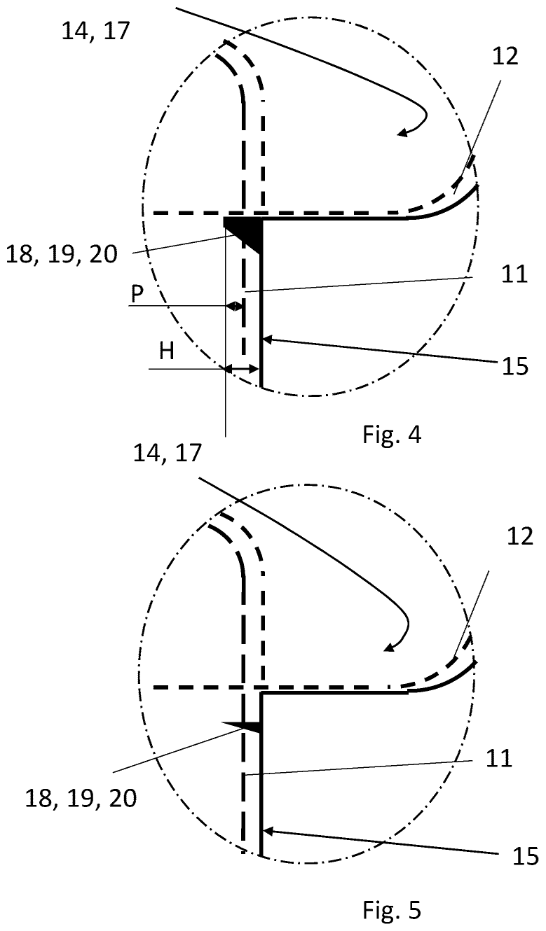

FIGS. 3 to 5 show the first mold part in cross-section. As can be seen, the first restriction element 18 and/or the second restriction element 19 can have different shapes in cross-section. The cross section of the first restriction element 18 and/or the second restriction element 19 as shown in FIG. 3 and FIG. 5 is in the shape of a triangle, while the first restriction element 18 and/or the second restriction element 19 as shown in FIG. 4 is in the shape of a trapezoid.

To solidify the mold material as fast as possible, in particular in the transition area between the insert element 12 and the molding element 11, the first mold part 13 and/or the second mold part 16 comprise at least one heating element 21. Thereby, at least one heating element 21 is arranged next to the first restriction element 18 and/or the second restriction element 19, as shown in FIG. 1.

The first restriction element 18 and/or the second restriction element 19 has a height H between 0 to 0.5 mm.

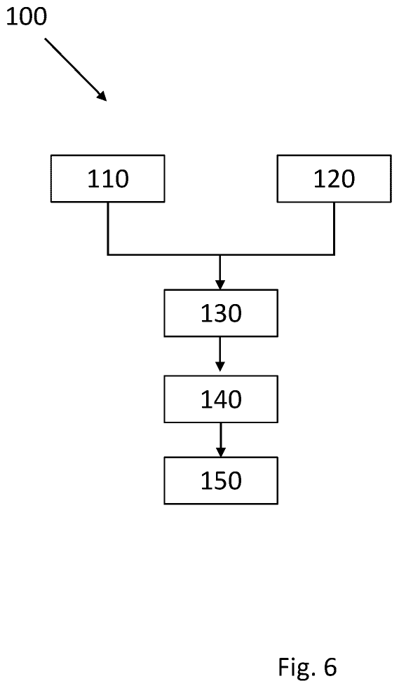

In FIG. 6 the method 100 to mold a molding element 11 to an insert element 12 in an injection molding tool 10 according to one of the FIG. 1 to 4, comprising the following steps: roviding 110 the first mold part 13 with the first mold surface 14, wherein the first restriction element 18 is arranged on the first mold surface 14; providing 120 the second mold part 16 with the second mold surface 17, wherein the second restriction element 19 is arranged on the second mold surface 17; inserting 130 the insert element 12 in the first mold part 13; placing 140 the second mold part 16 on the first mold part 13 to form the mold cavity 15, thereby closing the injection molding tool 10; filling 150 the mold cavity 15 of the injection molding tool 10 with mold material to mold the molding element 11 to the insert element 12, whereby the mold flow of the mold material is influenced by the first restriction element 18 and/or second restriction element 19.

As shown in FIG. 4, the insert element 12 is inserted 130 into the first mold part 13 adjacent to the first restriction element 18 and/or the second mold part 16 is placed 140 on the first mold part 13 such that the insert element 12 is adjacent to the second restriction element 19.

To prevent overmolding of the area between the insert element 12 and the molding element 11, the first restriction element 18 and/or the second restriction element 19 penetrate the molding element 11 in the closed state with a penetration depth P. Thereby, the penetration depth P of the first restriction element 18 and/or the second restriction element 19 in the insert element 12 is 0 to 0.5 mm.

It is conceivable that the first and/or second restriction element 19 penetrates the insert element 12 with a penetration depth of 0 to 0.5 mm.

As shown in FIG. 5 the insert element 12 is inserted 130 into the first mold part 13 at a distance D from the first restriction element 18 and/or the second mold part 16 is placed 140 on the first mold part 13 such that the insert element 12 is at a distance D from the second restriction element 19. The distance D between the first restriction element 18 and the insert element 12 and/or the second restriction element 19 is 0 to 0,5 mm, in particular, 0.01 to 0.3 mm, and further, in particular 0.05 to 0.2 mm.

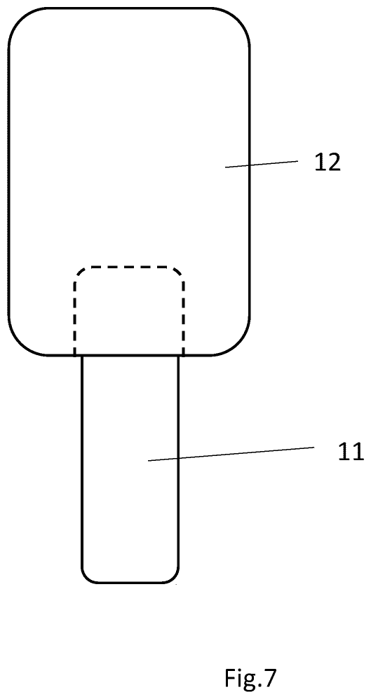

FIG. 7 shows a molding product 22 comprising an insert element 12 and a molding element 11, whereby the molding element 11 is molded to the insert element 12 according to the method 100 shown in FIG. 6 in an injection molding tool 10 shown in FIG. 1 to FIG. 5.

List of reference numbers:
10 Injection molding tool
11 molding element
12 insert element
13, 13a, 13b first mold part
14 first mold surface
15 mold cavity
16, 16a, 16b second mold part
17 second mold surface
18 first restriction element
19 second restriction element
20 restriction edge
21 heating element
22 molding product
100 method
110 providing the first mold part
120 providing the first mold part
130 inserting
140 placing
150 filling
H height
P penetration depth
D distance

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An injection molding tool for molding a molding element to an insert element which is insertable in the injection molding tool, wherein the injection molding tool comprises:
a first mold part with a first mold surface for delimiting a mold cavity; and
a second mold part with a second mold surface for delimiting the mold cavity;
wherein the first mold part and the second mold part form the mold cavity in a closed state of the injection molding tool; and
a first restriction element arranged on one of the first mold surface and the second mold surface for restricting the mold flow during an injection process of the molding element and a second restriction element is arranged on the second mold surface for restricting the mold flow during the injection process of the molding element.

2. The injection molding tool according to claim 1, wherein the first mold part is formed in several parts or the second mold part is formed in several parts.

3. The injection molding tool according to claim 1, wherein the first restriction element and the second restriction element is a restriction edge.

4. The injection molding tool according to claim 1, wherein a cross section of the restriction element is in the shape of a triangle.

5. The injection molding tool according to claim 1, comprising at least one heating element, wherein the at least one heating element is arranged next to the first restriction element or the second restriction element.

6. The injection molding tool according to claim 1, wherein the first restriction element or the second restriction element has a height between 0 to 0.5 mm.

7. The injection molding tool according to claim 1, wherein the first restriction element or the second restriction element has at least one interruption for flow redirection.

8. The injection molding tool according to claim 1, wherein the first restriction element or the second restriction element is subdivided into segments, wherein the segments are arranged offset to each other.

9. A method to mold a molding element to an insert element in an injection molding tool, comprising:
providing an injection molding tool comprising a first mold part and a second mold part, wherein the first mold part and the second mold part form a mold cavity in a closed state of the injection molding tool;
providing the first mold part with a first mold surface, wherein a first restriction element is arranged on the first mold surface;
providing the second mold part with a second mold surface, wherein a second restriction element is arranged on the second mold surface;
inserting the insert element in the first mold part;
placing the second mold part on the first mold part to form the mold cavity, thereby closing the injection molding tool; and
filling the mold cavity of the injection molding tool with mold material to mold the molding element to the insert element, whereby the mold flow of the mold material is influenced by at least one of the first restriction element and the second restriction element.

10. The method according to claim 9, wherein the insert element is inserted into the first mold part adjacent to the first restriction element and the second mold part is placed on the first mold part such that the insert element is adjacent to the second restriction element.

11. The method according to claim 9, wherein at least one of the first restriction element and the second restriction element penetrate at least one of the insert element and the molding element in the closed state with a penetration depth.

12. The method according to claim 11, wherein the penetration depth is 0 to 0.5 mm.

13. The method according to claim 12, wherein the insert element is inserted into the first mold part at a distance from the first restriction element and the second mold part is placed on the first mold part such that the insert element is at a distance from the second restriction element.

14. The method according to claim 13, wherein the distance between the first restriction element and the insert element is 0 to 0.5 mm, and the distance between the second restriction element and the insert element is 0 to 0.5 mm.

15. A molding product comprising an insert element and a molding element, whereby the molding element is molded to the insert element according to the method of claim 9.
